(19) United States
(12) Patent Application Publication
(10) Pub. No.: US 2021/0170230 A1
(43) Pub. Date: Jun. 10, 2021

(54) SYSTEMS AND METHODS FOR TRAINING PLAYERS IN A SPORTS CONTEST USING ARTIFICIAL INTELLIGENCE

(71) Applicant: Acronis International GmbH, Schaffhausen (CH)

(72) Inventors: Alexander Tormasov, Moscow (RU); Serguei Beloussov, Costa Del Sol (SG); Stanisiav Protasov, Moscow (RU)

(21) Appl. No.: 17/066,528

(22) Filed: Oct. 9, 2020

Related U.S. Application Data
(63) Continuation of application No. 17/026,738, filed on Sep. 21, 2020.
(60) Provisional application No. 62/944,561, filed on Dec. 6, 2019.

(51) Int. Cl. A63B 24/00; G06T 5/50; G06N 20/00; G06T 7/55

(52) U.S. Cl. CPC A63B 24/0021; G06T 5/50; G06N 20/00; A63B 2024/0025; G06T 7/55; A63B 24/0087; A63B 24/0006

(57) ABSTRACT

Disclosed herein are systems and method for training a player in a sports contest. In an exemplary aspect, a method may comprise receiving a strategy to be implemented in a sports contest by at least one player. The method may comprise determining a success rate of the strategy based on historical data of the at least one player. In response to determining that the success rate is less than a threshold success rate, the method may comprise identifying game obstacles in instances where the strategy was implemented by the at least one player and did not achieve the goal. The method may comprise determining a modified strategy that minimizes encounters of the at least one player with the game obstacles and achieves the goal of the strategy. The method may comprise outputting a training procedure for implementing the modified strategy for presentation to the at least one player.

### CROSS-REFERENCE TO RELATED APPLICATIONS

This application is a continuation-in-part of U.S. Non-Provisional application Ser. No. 17/026,738 and claims the benefit of U.S. Provisional Application No. 62/944,561, filed Dec. 6, 2019, which is herein incorporated by reference.

### FIELD OF TECHNOLOGY

The present disclosure relates to the field of artificial intelligence (A.I), and, more specifically, to systems and methods for training players in a sports contest using A.I.

### BACKGROUND

In various team games (e.g., sports and educational), for a successful result, it is important that the players are optimally located in the sports environment (i.e., are at the right place at the right time in the game depending on the specific situation and the goal). Thus there is a need to determine the correct position on the field for team members depending on each specific moment of the game. Traditionally, this need is addressed using team training and with the help of a coach. However, manual training demands that players memorize an endless amount of game strategies and spend several countless hours in team training. Even with the countless hours of team training, it is possible that certain game scenarios may not be trained for, leaving unfamiliarity when a player actually sees such a scenario during a competitive sports contest. Moreover, some strategies used by teams or players may be ineffective and may require modification/adaption to enhance the success rate of the teams or players. There thus also exists a need to train players based on the effectiveness of team strategies.

### SUMMARY

Aspects of the disclosure relate to the field of artificial intelligence. In particular, aspects of the disclosure describe methods and systems for training players in a sports contest using A.I.

In an exemplary aspect, a method may comprise receiving a strategy to be implemented in a sports contest by at least one player, wherein the strategy comprises player movement information and a goal of the strategy. The method may comprise determining a success rate of the strategy based on historical data of the at least one player in the sports contest. In response to determining that the success rate is less than a threshold success rate, the method may comprise identifying game obstacles in instances where the strategy was implemented by the at least one player and did not achieve the goal. The method may comprise determining a modified strategy that (1) minimizes encounters of the at least one player with the game obstacles and (2) achieves the goal of the strategy, wherein an encounter represents a moment in the sports contest when the at least one player is within a threshold distance from any game obstacle. The method may comprise outputting a training procedure for implementing the modified strategy for presentation to the at least one player.

In some aspects, in response to determining that the success rate is not less than a threshold success rate, the method may comprise outputting a different training procedure for implementing the received strategy for presentation to the at least one player.

In some aspects, the method for determining the modified strategy may comprise identifying an original path of movement that intersected with a game obstacle, identifying a different path of movement that can avoid intersecting with the game obstacle, and determining the modified strategy such that the original path is replaced with the different path.

In some aspects, the training procedure is a step-by-step instructive output that teaches the at least one player when and what actions to perform during the sports contest.

In some aspects, the method for outputting the training procedure may comprise generating an augmented reality or virtual reality version of the step-by-step instructive output, wherein the augmented reality or virtual reality version generates action prompts based on progress of the at least one player in the sports contest.

In some aspects, the success rate represents an amount of times the goal was achieved out of an amount of times the strategy was implemented.

In some aspects, the training procedure comprises predicted movements of opposing players and reactive actions to perform.

In some aspects, the method for determining the success rate is further based on historical data of another player that is not the at least one player, wherein the strategy is a universal strategy implemented by both the at least one player and the another player.

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating sports environment being captured by plurality of depth sensors, in accordance with aspects of the present disclosure.

FIG. 2 is a block diagram illustrating a computing device for providing a strategic game recommendation in a sports contest, in accordance with aspects of the present disclosure.

FIG. 3 is a diagram illustrating data flow in the modules of the system that provides the strategic game recommendation, in accordance with aspects of the present disclosure.

FIG. 4 is a diagram illustrating data flow in the modules of the system that provides the strategic game recommendation based on movement predictions, in accordance with aspects of the present disclosure.

FIG. 5 illustrates a flow diagram of a method for providing a strategic game recommendation in a sports contest, in accordance with aspects of the present disclosure.

FIG. 6 is a block diagram illustrating a computing device for training players in a sports contest, in accordance with aspects of the present disclosure.

FIG. 7 illustrates a flow diagram of a method for training players in a sports contest, in accordance with aspects of the present disclosure.

FIG. 8 presents an example of a general-purpose computer system on which aspects of the present disclosure can be implemented.

### DETAILED DESCRIPTION

Exemplary aspects are described herein in the context of a system, method, and computer program product for providing a strategic game recommendation in a sports contest. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure uses artificial intelligence (A.I) and machine learning algorithms to control and analyze situations in a game and generate timely instructions to players on their location on the field in real time. When a player relies on training provided by a coach, the player is only aware of a limited number of ways to position himself/herself. The use of A.I can enhance the player's reactive knowledge because the A.I can be trained using datasets extracted from all types of teams and players (not just the player's own specific team) from throughout history. The automated recommendations on how to react to a specific situation for all team members so that they monitor the overall situation in the game still enables each player to independently make a decision on how he/she thinks the game should be approached. In response, the A.I can reassess the situations in the game and provide further recommendations in real time.

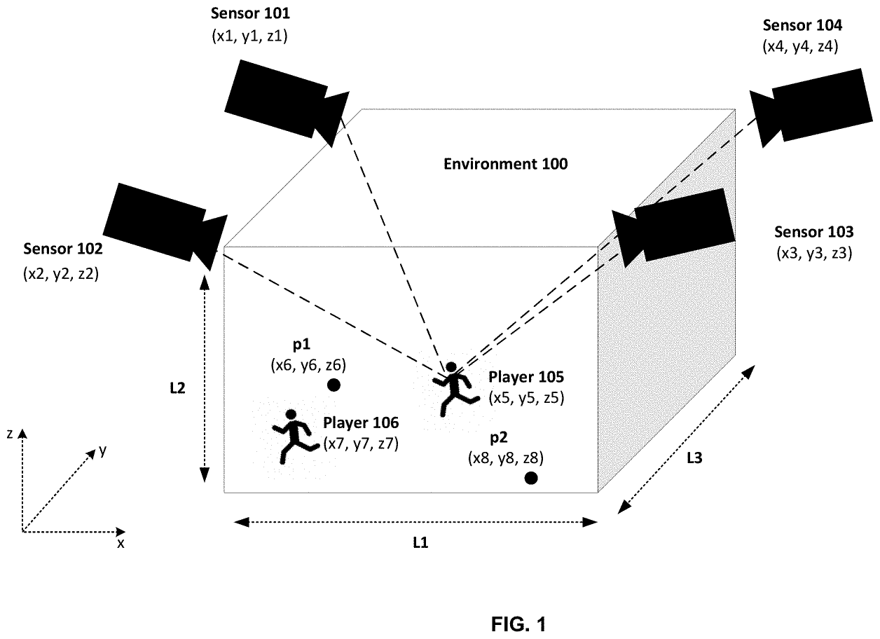

FIG. 1 is a block diagram illustrating sports environment 100 being captured by plurality of depth sensors, in accordance with aspects of the present disclosure. For simplicity, environment 100 is depicted as a rectangular volume with length L1, height L2, and width L3. However, environment 100 may be in any arbitrary shape. For example, environment 100 may be a gymnasium, a court, a field, an arena, etc., where a sports content is held. Depth sensors 101, 102, 103, and 104 may be used to acquire depth and image information associated with environment 100 and the people/objects in environment 100. For example, depth sensors 101-104 may continuously or periodically acquire a video stream of environment 100 along with depth information associated with each of the plurality of players (e.g., player 105, player 106, etc.) in environment 100. An example of a depth sensor may be a Microsoft Kinect. It should be noted that four VR sensors are depicted in FIG. 1 for simplicity. Depending on the size of environment 100, however, any number of depth sensors can be utilized. In FIG. 1, the location of sensors 101-104 are (x1, y1, z1), (x2, y2, z2), (x3, y3, z3), and (x4, y4, z4), respectively, in standard three-dimensional coordinates. Given the length, height, and width of environment 100, the locations of each sensor can be expressed relative to another sensor. For example, the location (x3, y3, z3) of sensor 103 may also be written as (x1+L1, y1+L3, z1). In some aspects, the value of z1 may equal z2, z3, and z4. For example, z1, z2, z3, and z4 may all be 10 meters. In some aspects, sensors 101-104 are placed at a tilt angle to better capture the environment 100. For example, the tilt angle of each sensor may be 20 degrees relative to the z-axis.

Furthermore, the depth sensors 101-104 may be placed in any position, although preferably they are placed in locations such that the entire environment 100 is captured by the collective depth information acquired by the depth sensors. For example, four sensors may be placed at the corners of environment 100 (as depicted), four depth sensors may be placed at the midpoints between the corners (i.e., one on each side of environment), and another depth sensor may be placed on the ceiling of environment 100 to capture information from an overhead perspective. In FIG. 1, suppose that each sensor 101 equally captures 25% of the rectangular volume. In some aspects, there may be an overlap in the depth information captured by each sensor. For example, if each sensor captures 30% of the volume, there is a total 20% overlap in the collective depth information.

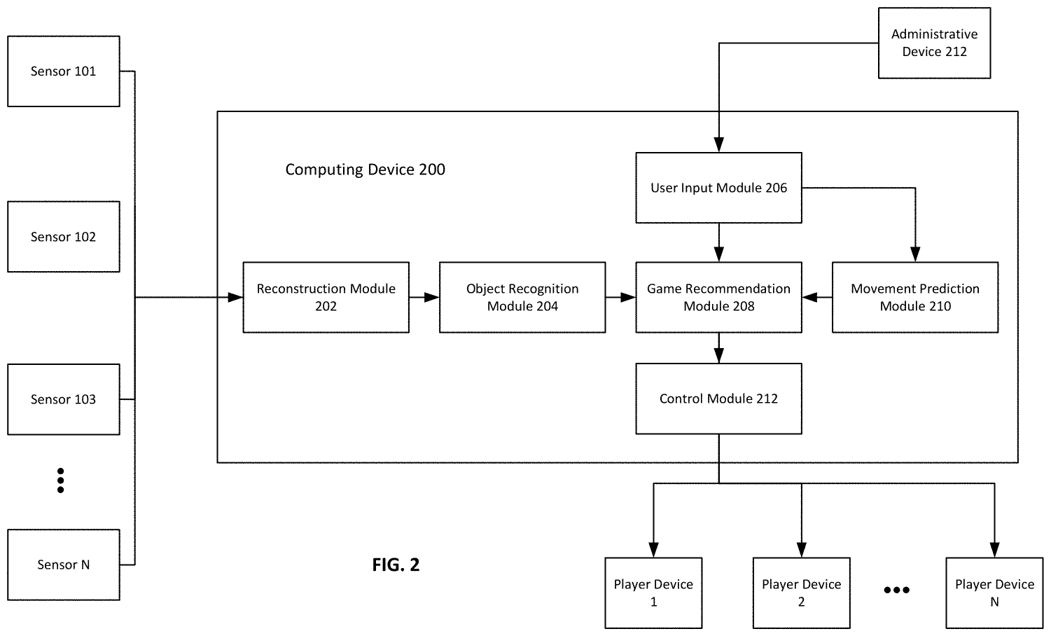

FIG. 2 is a block diagram illustrating computing device 200 for providing a strategic game recommendation in a sports contest, in accordance with aspects of the present disclosure. As can be seen, sensors 101, 102, 103, . . . N, communicate with computing device 200. The communication may be over a wired (e.g., USB or Ethernet cables) and/or a wireless (e.g., Wi-Fi, Bluetooth, etc.) medium. Likewise, computing device 200 may communicate with administrative device 214 and player devices 1, 2, . . . N over a wired and/or wireless medium.

Computing device 200 comprises a plurality of modules, which may be individual components of a software that receives data from sensors 101-N, administrative device 214, and player devices 1-N, and outputs recommendations to administrative device 214 and/or player devices 1-N. Among the modules are reconstruction module 202, object recognition module 204, user input module 206, game recommendation module 208, movement prediction module 210, control module 212.

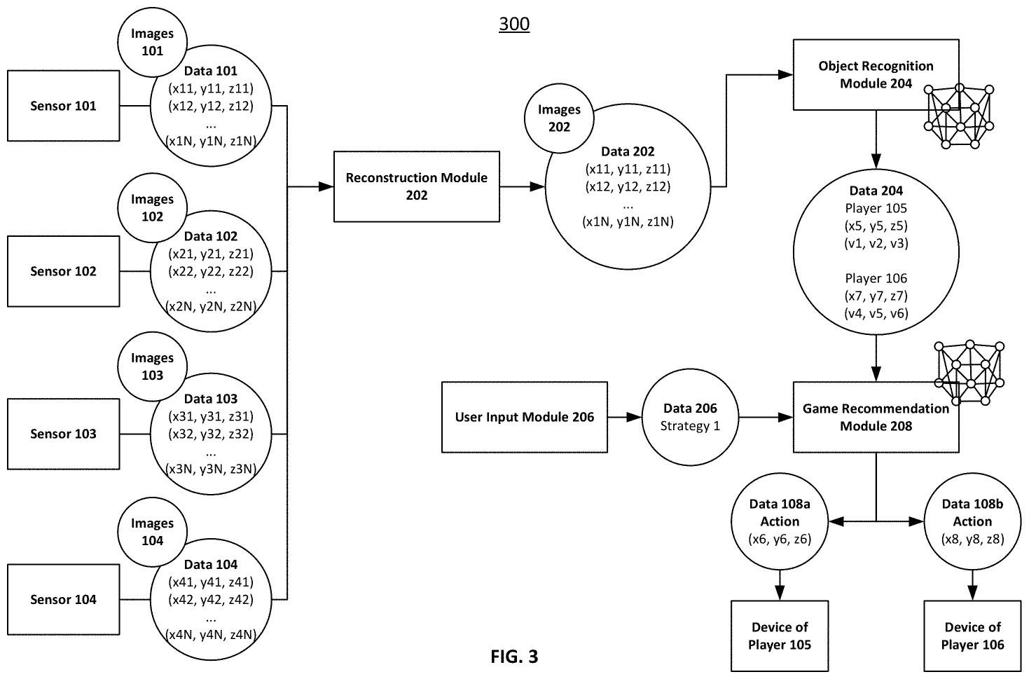

FIG. 3 is a diagram illustrating data flow 300 in the modules of the system that provides the strategic game recommendation, in accordance with aspects of the present disclosure. Referring to FIG. 1, four depth sensors acquire image and depth information. The acquired information is then sent to reconstruction module 202. For example, sensor 101 transmits images 101 and data 101. Likewise, sensor 102 transmits images 102 and data 102. Sensor 103 transmits images 103 and data 103. Sensor 104 transmits images 104 and data 104. The information may be transmitted in real time such that images and data depicted in FIG. 3 is for a specific time t1 (e.g., 3:01:32 pm).

The image information may be images tagged with timestamps. The depth information may be a point cloud comprising a plurality of points where a physical object exists. For example, depth sensors 101-104 may generate 5000 depth points that are on the surface of a player. Each depth point may be formatted in the format (x, y, z) and may be relative to the location of the sensor. For example, a sample depth point may be (5 meters, 6 meters, −1 meter) from sensor 101, which indicates that the data point is 5 meters to the right, 6 meters ahead, and 1 meter below the location of sensor 101, (x1, y1, z1). If the sample depth point was (−5 meters, −6 meters, and −1 meter), reconstruction module 202 would interpret the point as being 5 meters to the left, 6 meters behind, and 1 meter below the location of sensor 101.

Accordingly, reconstruction module 202 receives, over a period of time, images and depth information from a plurality of sensors distributed in environment 100 of a sports contest. In response to receiving images 101-104 and data 101-104, reconstruction module 202 is configured to generate a unified visual representation of environment 100. The unified visual representation comprises images 202 and data 202. Specifically, reconstruction module 202 searches for overlaps in data 101-104 by converting all depth data to be relative to a single origin point. For example, if sensor 101 is at the location (x1, y1, z1) and data 101 comprises a point (a, b, c), the point expressed relative to sensor 101's position is (x1+a, y1+b, and z1+c). Because the difference between sensor 101 and sensor 102 is L3 along the y-axis, the point relative to sensor 102 may be expressed as (x1+a, y1+L3+b, z1+c). Accordingly, reconstruction module 202 generates data 202, in which all depth points are relative to a single origin point (either a point in environment 100 or one of the sensor's locations) and removes duplicate points. For example, if two points are found with the value (10, 15, −4), one of the points will be removed from data 202. It should be noted that reconstruction module 202 may be programmed to anticipate data from four sensors and may also be provided with the location of each sensor to perform unification calculations.

In some aspects, images 101-104 each include one image representing a view from a respective sensor 101-104 at a given time (e.g., t1, t2, t3, etc.). Reconstruction module 202 generates images 202, which comprises an image from each sensor at a given time. Each image is further tagged with an identifier of the sensor that captured the image. The tags for each image are found in the metadata of the image.

Reconstruction module 202 provides the unified visual representation (e.g., images 202 and data 202) as an input to object recognition module 204, which is configured to identify objects in an input point cloud and highlight their locations in data 204. In some aspects, object recognition module 204 is a neural network, which may be trained using point clouds and images of various objects such as players, game equipment, referees, seats, tables, etc. Using these point cloud and image datasets, neural network 1 may output a data structure (e.g., data 204) listing each classified object within environment 100 and the relative position of the object with respect to the origin point. Suppose, that three objects are identified in a given scenario: Lebron James, a basketball hoop, and a basketball. The data structure may be [{Lebron James, (4 meters, 5 meters, 1.5 meters)}, {basketball hoop, (10 meters, 0 meters, 2.7 meters), {basketball, (4 meters, 5.05 meters, 0.5 meters)}]. In some aspects, the output position of a given object describes the center point of the object (e.g., determined by averaging out all depth points on the surface of the object). In other aspects, each object is represented by a basic shape, such as a rectangular prism, to account for the volume of the object. For example, if Lebron James is 2.06 meters tall, 0.91 meters wide, and 0.305 meters in depth, when identifying Lebron James in the output data structure, these dimensions along with the location coordinates of Lebron James may be provided. This is allows for collision prevention when the data structure is provided to game recommendation module 208 as module 208 will not recommend going to a location where an obstacle exists. Relative to FIG. 1, object recognition module 204 detects player 105, which has the coordinates (x5, y5, z5) and volume (v1, v2, v3), and player 106, which has the coordinates (x7, y7, z7) and volume (v4, v5, v6).

The positional data of each object (e.g., player locations) over a period of time (e.g., 5 seconds), as described by the output data structure, is received by game recommendation module 208. Game recommendation module 208 then determines a game event/situation based on the positional data and recommends a game action (e.g., move to a different position, shoot the ball, pass the ball, etc.). Game recommendation module 208 may be another neural network that is trained using strategies of certain teams. In some aspects, game recommendation module 208 may receive these strategies via user input module 206. User input module 206 enables an administrative device or a player device to provide a game plan. For example, in basketball, an example game plan may be a pick and roll, in which one player serves as a temporary obstacle (called “setting a pick”) for an opposing player while another teammate with the basketball runs past the opposing player. This enables the teammate to either score (because the opposing player was temporarily slowed down from defending), or allows the one player to run towards the basketball hoop (called “rolling”) in an attempt to score while the teammate serves as a distraction. In the latter, the teammate passes the ball to the one player when the one player arrives underneath the basketball hoop and the one player shoots. A game strategy can be provided by a coach of a team or a team player. The game strategy may be a provided via user input module 206 as an image with arrows indicative of desired player movement, a game strategy name and the names of players involved (e.g., Lebron James, Anthony Davis, pick & roll), or a verbal input that user input module 206 parses via speech recognition. In some aspects, user input module 206 may be a user interface through which a coach can draw out a game plan through arrows. User input module 206 may convert these arrows into a plurality of vectors representing the movements that a player is assigned to make to carry out the game plan.

User input module 206 is configured to provide a strategy (e.g., data 206) to game recommendation module 208. In some aspects, data 206 indicates the game strategy qualitatively represented (e.g., “pick and roll with player 105 and player 106”) or quantitatively represented (e.g., a plurality of vectors received from the user interface). In some aspects, game recommendation module 208 may download strategies and movements from a database that includes vector movements if the strategy is provided qualitatively.

In some aspects, the strategy may not be directly provided and game recommendation module 208 may determine strategy using a plurality of positional data structures. Using the timestamps, game recommendation module 208 may determine the change in position of the classified objects. For example, at time t1, player 105 may be at position (4 meters, 5 meters, 1.5 meters) and at t2, player 105 may be at position<4.5 meters, 5 meters, 1.5 meters>. Based on the positional data and/or the changes in positional data, game recommendation module 208 may determine that player 105 is a part of a first team that is running a basketball strategy called “the triangle offense.” Each strategy may be associated with template data structures that indicate where each object should be. In this case, the triangle offense may also be associated with the data structure [{Player 1, <4 meters, 5 meters, 1.5 meters>}, {basketball hoop, <10 meters, 0 meters, 2.7 meters>, {basketball, <4 meters, 5.05 meters, 0.5 meters>}]. Game recommendation module 208 may determine that because the positional data matches the data structure of the triangle offense, the strategy is triangle offense.

Subsequent to receiving/determining the strategy, game recommendation module 208 may identify a game event, based on the strategy and the positional data of each player and object in environment 100 over a period of time. For example, if player 105 is at position (x5, y5, z5), and player 106 is at position (x7, y7, z7), player 105 has the basketball, and the strategy is pick and roll with player 105 and player 106, game recommendation module 208 may determine that at time t1, player 106 is setting a pick for player 105. To continue the pick and roll movements as indicated in the received game strategy (e.g., rolling), game recommendation module 208 may recommend that player 105 move to position (x6, y6, z6) and that player 106 move to position (x8, y8, z8).

The game action (used interchangeably with strategic game recommendation) seeks to enable a player to implement the received strategy and minimize encounters with game obstacles. Game obstacles may be opposing players that seek to prevent the player from implementing the strategy. For example, if a player is performing the pick and roll strategy, the defender is a game obstacle that attempts to prevent the player from scoring using the pick and roll. If it appears that the game obstacle will succeed in preventing implementation of the strategy (e.g., by standing in front of the player), the strategic game recommendation may modifies a player movement in the strategy (in response to determining that the game obstacle will successfully prevent implementation of the strategy, based on the positional data of the player and the additional positional data of the opposing player).

In some aspects, when providing a game recommendation, module 208 may also consider player intent. The intent of a player represents a prediction of what the player will do within the next threshold period of time. For example, a player may pass the ball, run a certain distance in a particular direction, shoot the ball, exit the game, call a timeout, etc. Each game event may be associated with an intent for each respective player in environment 100. For example, according to the triangle offense game plan, player 105 at the position (x5, y5, z5) may shoot the ball within a threshold period of time (e.g., 3 seconds). Because player 105 is at that position at time t1, game recommendation module 208 may determine that player 105's intent is to shoot the ball. However, if 3 seconds pass and player 105 does not shoot the ball, module 208 may determine that player 105 does not intend to shoot the ball and may either recommend a movement, passing the ball, or calling a timeout.

In some aspects, when providing a game recommendation, module 208 may also consider player fatigue. For example, game recommendation may also receive biometric data from a device equipped to a player. The device may capture information such as heart rate, blood pressure, perspiration, etc. Game recommendation module 208 may accordingly determine a fatigue level indicative of how exhausted a player is, as a function of the biometric data. In response to determining that the fatigue level (e.g., 90%) surpasses a threshold fatigue level (e.g., 50%), game recommendation module 208 may recommend calling a timeout and switching the player.

Accordingly, game recommendation module 208 may receive biometric data, data 204, data 206, and may determine player intent before generating a recommendation. In some aspects, module 208 may be configured to generate a strategic game recommendation for the player, wherein its neural network is trained using historic positional data and associated historic game events that led to successful results (e.g., successful scoring and passing) to identify the opposing players and optimize the chances of the player in achieving his/her intent. The strategic game recommendation may include a recommended route for traversal through environment 100 (wherein the recommended route is described using at least one vector and a distance), a recommendation to change the intent/strategy (e.g., to pass the ball instead of shoot), or even a recommendation to exit the sports contest (e.g., go to the bench and switch out with a different player).

The output of module 208 is sent to devices of players via control module 212, which is configured to identify the player that the recommendation is designated to and route the recommendation to the proper device of the player for presentation. For example, each player (e.g., players 105 and 106) may have a respective receiver device that can receive communication from control module 212 and output the communication to the player. Control module 212 may detect each respective receiver device in environment 100 and transmit a respective strategic game recommendation. A respective receiver device may be an earpiece, an augmented reality headset, a biometric device such as a smartwatch, etc. Presenting the strategic game recommendation may comprise at least one of generating, for display on a respective receiver device of a player, an augmented reality visualization depicting the strategic game recommendation, outputting an audio clip stating the strategic game recommendation, and generating, via the respective receiver device, a vibration indicating the strategic game recommendation.

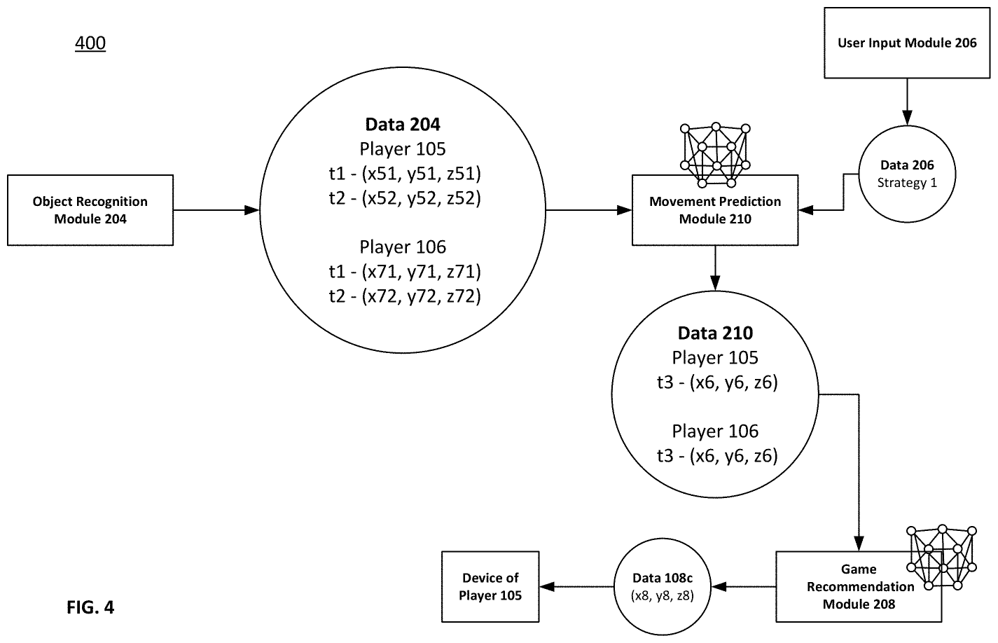

FIG. 4 is a diagram illustrating data flow in the modules of the system that provides the strategic game recommendation based on movement predictions, in accordance with aspects of the present disclosure. In FIG. 4, game recommendation module 208 receives an additional input, data 210, from movement prediction module 210. Suppose that player 105 and player 106 are on opposing teams. Player 105 may be receiving game recommendations from computing device 200. In some aspects, module 208 may shape its recommendations based on how the opposing team player 106 reacts. Accordingly, predicting how player 106 will move and their position at a future time allows module 208 to make a recommendation that avoids collision with player 106 and further prevents player 106 from disrupting/preventing implementation of a strategy. For example, in addition to capturing positional data of player 105, sensors 101-104 may capture additional positional data of at least one other player (e.g., player 106) in a second group of players (i.e., the opposing team). Game recommendation module may determine that the at least one other player is a game obstacle and recommend a game action that player 105 avoids contact with player 106. More specifically, movement prediction module 210 may predict, based on the positional data of player 105, that player 105 will be located at a first location (e.g., (x6, y6, z6) in environment 100 at a subsequent time. This prediction may be based on the trajectory of player 105 over a period of time and the speed of player 105. For example, if player 105 is running along a vector at a constant speed of 4 meters per second, movement prediction module 210 may estimate the future location of player 105 to be along the vector at a distance proportional to the speed (e.g., 16 meters ahead of the current point along the vector in 4 seconds). Likewise, module 210 may predict, based on the additional positional data of player 106, that the at least one other player will be located at a second location at the subsequent time. This location may be in the vicinity of the first location (x6, y6, z6). In response to determining that the first location and the second location are both within a threshold distance (e.g., 0.5 meters), module 208 may determine that player 106 is a game obstacle to player 105. To avoid player 106, player 105 may be recommended to run towards point (x8, y8, z8) instead. This point may recommended in accordance with a different variation of the strategy, which may be retrieved from a strategy database.

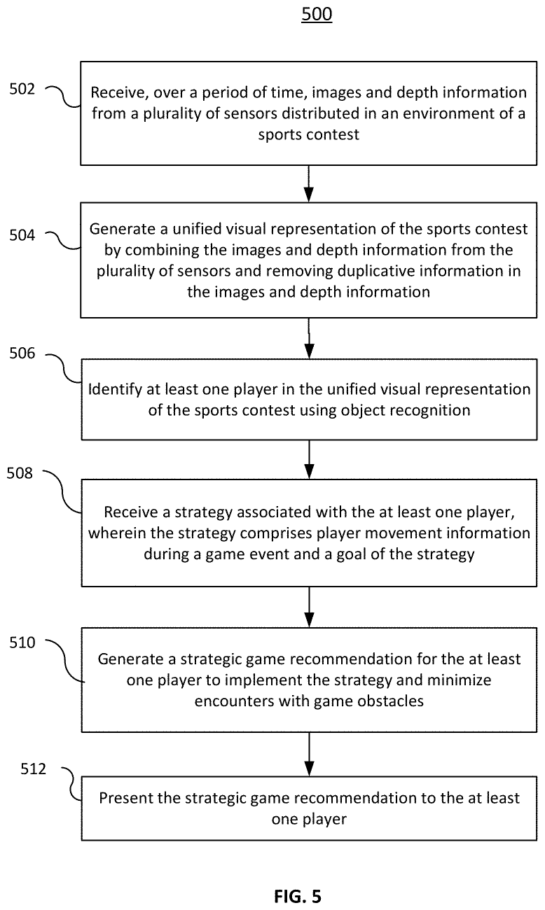

FIG. 5 illustrates a flow diagram of method 500 for providing a strategic game recommendation in a sports contest, in accordance with aspects of the present disclosure. At 502, reconstruction module 202 receives, over a period of time, images and depth information from a plurality of sensors distributed in an environment (e.g., environment 100) of a sports contest. At 504, reconstruction module 202 generates a unified visual representation of the sports contest (e.g., images 202 and data 202) by combining the images and depth information from the plurality of sensors and removing duplicative information in the images and depth information. At 506, object recognition module 204 identifies (e.g., in data 204) at least one player in the unified visual representation of the sports contest using object recognition. At 508, user input module 206 receives a strategy (e.g., data 206) associated with the at least one player, wherein the strategy comprises player movement information during a game event and a goal of the strategy. At 510, game recommendation module 208 generates a strategic game recommendation for the at least one player (e.g., data 108a, b, etc.) to implement the strategy and minimize encounters with game obstacles. At 512, control module 212 presents the strategic game recommendation to the at least one player.

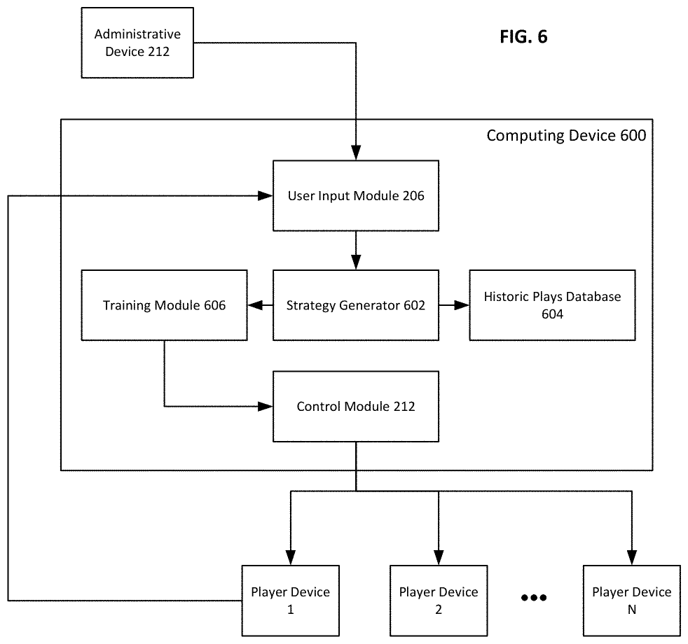

FIG. 6 is a block diagram illustrating computing device 600 for training players in a sports contest, in accordance with aspects of the present disclosure.

In addition to providing game recommendations, implementations of the present disclosure may be used to evaluate the effectiveness of team strategies and provide training to players based on strategies that have historically worked. For example, a player may be wearing an augmented reality headset (e.g., player device 1), which may be connected to computing device 600. Computing device 600 may have user input module 206 and control module 212, just like computing device 200. In addition, computing device 600 may store modules including strategy generator 602 and training module 606, and a database for historic plays (e.g., database 604).

In an exemplary aspect, training module 606 is used to train players to implement game strategies. User input module 206 may generate, for display, a plurality of strategies that a user (e.g., a player, a coach, a manager, etc.) may select from. Suppose that a basketball player wants to practice the pick and roll strategy or a coach wants to train his/her team to execute the pick and roll strategy. User input module 206 may receive a strategy to be implemented in a sports contest (e.g., basketball) by the player and/or teammates of the player. As discussed before, the strategy may indicate player movement information and a goal of the strategy. For example, user input module 206 may receive a selection of the pick and roll strategy via a touch-screen of computing device 600. In some cases, a client of module 206 may be installed on administrative device 212 or one or more of player devices 1-N. Accordingly, a player or coach may make a selection of a strategy on device 212 or one or more of devices 1-N. Subsequently, the selection may be received at computing device 600 via a wired/wireless transmission of devices 212/1-N.

Strategy generator 602 may then determine a success rate of the strategy based on historical data of the at least one player in the sports contest. Strategy generator 602 seeks to optimize the received strategy (if possible). The success rate represents an amount of times the goal was achieved out of an amount of times the strategy was implemented. For example, strategy generator 602 may identify historical data in historic plays database 604. Database 604 may store videos of a particular team or group of teams running plays such as the pick and roll. In some cases, the videos may be accompanied by statistics (e.g., indicating scores, player contributions, etc.). In some aspects, the videos may be annotated (e.g., indicating in text the plays that were being run, the pathways each player took, whether a ball was scored or turned over, etc.) and the annotations may be stored as metadata. In some aspects, database 604 may simply store the annotations without the actual videos.

Strategy generator 602 may identify historic plays associated with the selected strategy and determine the number of historic plays that exist in database 604 (e.g., 400 plays of the pick and roll) and the number of those historic plays that were successful (e.g., 200 plays led to achieving the goal of scoring a point). In some aspects, the historic plays can be filtered based on teams, players, coaches, etc. For example, strategy generator 602 may only consider (when determining success rate) historic plays of the pick and roll that have been implemented by the player that selected that particular strategy. In another example, the player may indicate an opposing team/player and strategy generator 602 may only consider historic plays of the pick and roll that have been implemented against the opposing team/player. In some aspects, the strategy generator 602 may determine the success rate based on historical data of another player (e.g., a teammate or a former teammate). In this case, the strategy is a universal strategy implemented by several players and teams in a particular sport (such as the pick and roll).

Suppose that the selected strategy has been attempted 400 times and only has led to the goal being achieved 200 times. The success rate is thus 50%. Strategy generator 602 may then evaluate whether the success rate is adequate, by comparing the success rate with a predetermined threshold success rate (e.g., 65%).

In response to determining that the success rate is less than the threshold success rate, strategy generator 602 may attempt to optimize the selected strategy. More specifically, strategy generator 602 may identify game obstacles in instances where the strategy was implemented by the at least one player and did not achieve the goal. For example, strategy generator 602 may analyze the historic plays in database 604 that were associated with the strategy and were unsuccessful.

In particular, strategy generator 602 may determine what led to an unsuccessful outcome. In the overarching example, the pick and roll strategy may be unsuccessful if the player shoots and misses, if an opposing player blocks/steals the ball, or if an opposing player prevents a pass. In each case, the biggest game obstacle is an opposing player. Strategy generator 602 may thus identify tendencies of the game obstacle (i.e., opposing player) in the unsuccessful plays. For example, strategy generator 602 may determine that in a majority of the unsuccessful plays, the player uses a specific path (e.g., goes left when a pick is set by a teammate) and then opposing player either prevents a pass, steals the ball, or blocks a shot attempt.

Strategy generator 602 may thus determine a modified strategy that (1) minimizes encounters of the at least one player with the game obstacles and (2) achieves the goal of the strategy, wherein an encounter represents a moment in the sports contest when the at least one player is within a threshold distance from any game obstacle. For example, because the player normally uses a specific path that leads to the opposing player being able to reach and stop the player from achieving the goal, strategy generator 602 may determine that the player should use a different path (e.g., go to the right-side when a pick is set, instead of the left). This will create a greater distance between the player and the opposing player (who historically has moved left a majority of the times the play was unsuccessful). This modified version of the pick and roll does not change the goal, uses generally the same components of a traditional pick and roll (i.e., a pick is set by a teammate who later “rolls” towards the basket), and increases the distance between the player and the opposing player that is guarding the player.

In some aspects, strategy generator 602 may identify, in the historic plays that were unsuccessful, pathways that a player may take that ensure that the player will be a threshold distance (e.g., 2 feet) away from all game obstacles on the court (e.g., opposing players, court boundaries, referees, etc.) while reaching a desired destination on the court. Strategy generator 602 may then replace the previously used pathway with the identified pathway. More technically, strategy generator 602 may identify an original path of movement that intersected with a game obstacle, identify a different path of movement that can avoid intersecting with the game obstacle, and determine the modified strategy such that the original path is replaced with the different path.

Training module 606 may receive the modified strategy from strategy generator 602 and generate a training procedure. The training procedure may be a step-by-step instructive output that teaches the at least one player when and what actions to perform during the sports contest.

For example, the training procedure for an unmodified version of the pick and roll may be:

1. Player 1 (point guard) moves to position (X1, Y1, Z1) in the environment.
2. Player 2 (power forward) moves to position (X2, Y2, Z2) and sets a pick.
3. Player 1 moves to left side of player 2 to position (X3, Y3, Z3).
4. Player 2 stays at (X2, Y2, Z2) for 3 seconds.
5. Player 2 runs to position (X4, Y4, Z4).

5.1. Player 1 passes ball to player 2 when player 2 is halfway towards position (X4, Y4, Z4).

5.2. Player 2 shoots the ball when he/she reaches position (X4, Y4, Z4).

Because strategy generator 602 has changed the pathway of player 1 so that player 1 can make a pass to player 2, the modified training procedure may be:

1. Player 1 (point guard) moves to position (X1, Y1, Z1) in the environment.
2. Player 2 (power forward) moves to position (X2, Y2, Z2) and sets a pick.
3. Player 1 moves to right side of player 2 to position (X5, Y5, Z5).
4. Player 2 stays at (X2, Y2, Z2) for 3 seconds.
5. Player 2 runs to position (X4, Y4, Z4).

5.1. Player 1 passes ball to player 2 when player 2 is halfway towards position (X4, Y4, Z4).

5.2. Player 2 shoots the ball when he/she reaches position (X4, Y4, Z4).

In some aspects, the training procedure comprises predicted movements of opposing players and reactive actions to perform. For example, the training procedure may indicate where an opposing player will be positioned while players 1 and 2 execute the strategy at each step.

Training module 606 may then output the training procedure for implementing the modified strategy for presentation to the at least one player by transmitting the strategy to control module 212, which may distribute the strategy to the players involved in the procedure (e.g., player 1 and 2). In this case, control module 212 may transmit the training procedure to both player devices 1 and 2.

In some aspects, the method for outputting the training procedure may comprise generating an augmented reality or virtual reality version of the step-by-step instructive output, wherein the augmented reality or virtual reality version generates action prompts based on progress of the at least one player in the sports contest. For example, player device 1 may be a virtual reality headset that generates graphics to the player. Training module 606 may configure each training procedure program to detect the position of a player in an environment as well as the actions of the player to determine which step to generate for display. Suppose that player 1 has received the training procedure. Player device 1 may generate for a display a prompt for step 1, informing player 1 to move to position (X1, Y1, Z1). In response to detecting that player 1 has reached position (X1, Y1, Z1), player device 2 may generate a prompt for player 2 to move to position (X2, Y2, Z2) and set a pick. As each player performs each step, the next step is generated for display.

Strategy generator 602 may receive progress information from each player device and store the results in database 604. Based on whether the modified strategy is proving to be effective, strategy generator 602 may include the modified strategy in the plurality of strategies selectable by users or tweak the modified strategy further.

It should be noted that the modified strategy is not the only training procedure that may be output to a user. For example, in response to determining that the success rate of a selected strategy is not less than a threshold success rate, training module 606 may output the unmodified training procedure for implementing the received/selected strategy for presentation to the at least one player.

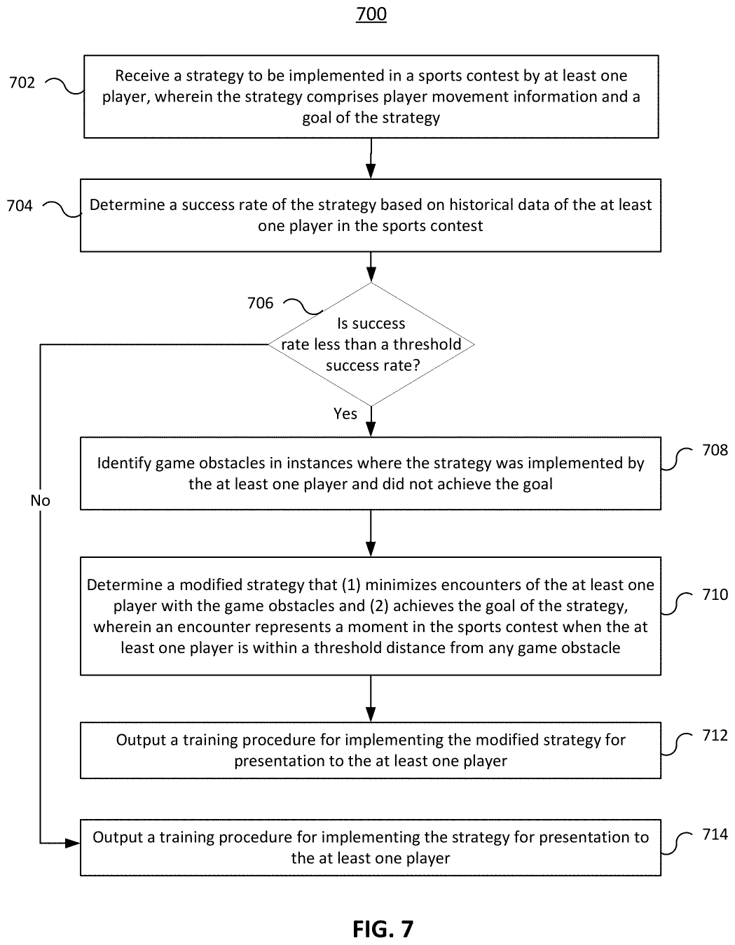

FIG. 7 illustrates a flow diagram of method 700 for training players in a sports contest, in accordance with aspects of the present disclosure. At 702, user input module 206 receives a strategy to be implemented in a sports contest by at least one player (e.g., player 105), wherein the strategy comprises player movement information and a goal of the strategy. At 704, strategy generator 602 determines a success rate of the strategy based on historical data (e.g., retrieved from historic plays database 604) of the at least one player in the sports contest.

At 706, strategy generator 602 determines whether the success rate (e.g., 60%) is less than a threshold success rate (e.g., 65%). In response to determining that the success rate is less than a threshold success rate, method 700 advances to 708, where strategy generator 602 identifies game obstacles in instances where the strategy was implemented by the at least one player and did not achieve the goal.

At 710, strategy generator 602 determines a modified strategy that (1) minimizes encounters of the at least one player with the game obstacles and (2) achieves the goal of the strategy, wherein an encounter represents a moment in the sports contest when the at least one player is within a threshold distance from any game obstacle.

At 712, training module 606 outputs a training procedure for implementing the modified strategy for presentation to the at least one player (e.g., via control module 212).

If at 706, strategy generator 602 determines that the success rate is not less than the threshold success rate, method 700 advances to 714, where training module 606 outputs a training procedure for implementing the strategy for presentation to the at least one player.

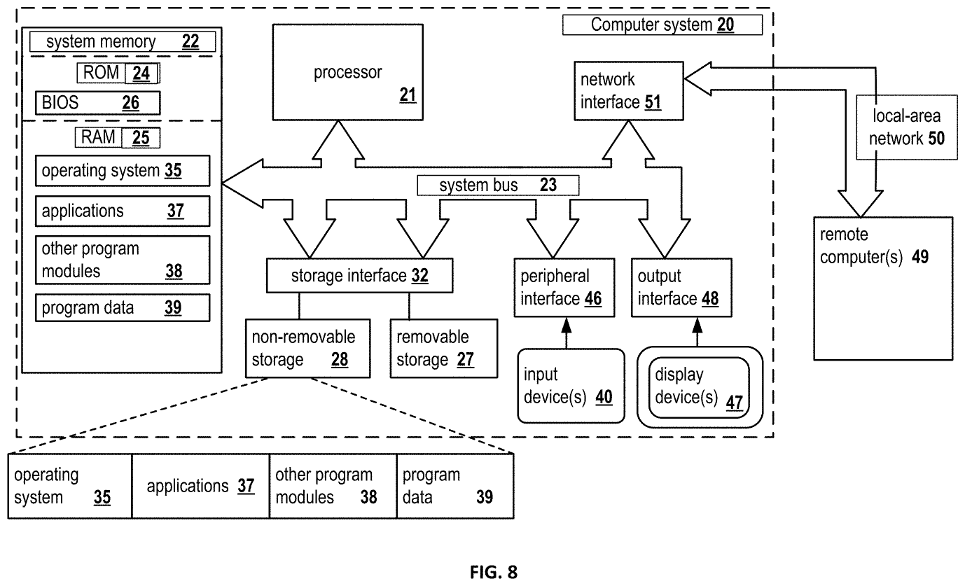

FIG. 8 is a block diagram illustrating a computer system 20 on which aspects of systems and methods for providing a strategic game recommendation in a sports contest may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for training players in a sports contest, the method comprising:
receiving a strategy to be implemented in a sports contest by at least one player, wherein the strategy comprises player movement information and a goal of the strategy;
determining a success rate of the strategy based on historical data of the at least one player in the sports contest;
in response to determining that the success rate is less than a threshold success rate, identifying game obstacles in instances where the strategy was implemented by the at least one player and did not achieve the goal;
determining a modified strategy that (1) minimizes encounters of the at least one player with the game obstacles and (2) achieves the goal of the strategy, wherein an encounter represents a moment in the sports contest when the at least one player is within a threshold distance from any game obstacle; and
outputting a training procedure for implementing the modified strategy for presentation to the at least one player.

2. The method of claim 1, further comprising:
in response to determining that the success rate is not less than a threshold success rate, outputting a different training procedure for implementing the received strategy for presentation to the at least one player.

3. The method of claim 1, wherein determining the modified strategy comprises:
identifying an original path of movement that intersected with a game obstacle;
identifying a different path of movement that can avoid intersecting with the game obstacle; and
determining the modified strategy such that the original path is replaced with the different path.

4. The method of claim 1, wherein the training procedure is a step-by-step instructive output that teaches the at least one player when and what actions to perform during the sports contest.

5. The method of claim 4, wherein outputting the training procedure comprises generating an augmented reality or virtual reality version of the step-by-step instructive output, wherein the augmented reality or virtual reality version generates action prompts based on progress of the at least one player in the sports contest.

6. The method of claim 1, wherein the success rate represents an amount of times the goal was achieved out of an amount of times the strategy was implemented.

7. The method of claim 1, wherein the training procedure comprises predicted movements of opposing players and reactive actions to perform.

8. The method of claim 1, wherein determining the success rate is further based on historical data of another player that is not the at least one player, wherein the strategy is a universal strategy implemented by both the at least one player and the another player.

9. A system for training players in a sports contest, the system comprising:
a hardware processor configured to:
receive a strategy to be implemented in a sports contest by at least one player, wherein the strategy comprises player movement information and a goal of the strategy;
determine a success rate of the strategy based on historical data of the at least one player in the sports contest;
in response to determining that the success rate is less than a threshold success rate, identify game obstacles in instances where the strategy was implemented by the at least one player and did not achieve the goal;
determine a modified strategy that (1) minimizes encounters of the at least one player with the game obstacles and (2) achieves the goal of the strategy, wherein an encounter represents a moment in the sports contest when the at least one player is within a threshold distance from any game obstacle; and
output a training procedure for implementing the modified strategy for presentation to the at least one player.

10. The system of claim 9, wherein the hardware processor is further configured to:
in response to determining that the success rate is not less than a threshold success rate, output a different training procedure for implementing the received strategy for presentation to the at least one player.

11. The system of claim 9, wherein the hardware processor is further configured to determine the modified strategy by:
identifying an original path of movement that intersected with a game obstacle;
identifying a different path of movement that can avoid intersecting with the game obstacle; and
determining the modified strategy such that the original path is replaced with the different path.

12. The system of claim 9, wherein the training procedure is a step-by-step instructive output that teaches the at least one player when and what actions to perform during the sports contest.

13. The system of claim 12, wherein the hardware processor is further configured to output the training procedure by generating an augmented reality or virtual reality version of the step-by-step instructive output, wherein the augmented reality or virtual reality version generates action prompts based on progress of the at least one player in the sports contest.

14. The system of claim 9, wherein the success rate represents an amount of times the goal was achieved out of an amount of times the strategy was implemented.

15. The system of claim 9, wherein the training procedure comprises predicted movements of opposing players and reactive actions to perform.

16. The system of claim 9, wherein the hardware processor is further configured to determine the success rate is based on historical data of another player that is not the at least one player, wherein the strategy is a universal strategy implemented by both the at least one player and the another player.

17. A non-transitory computer readable medium storing thereon computer executable instructions for training players in a sports contest, including instructions for:
receiving a strategy to be implemented in a sports contest by at least one player, wherein the strategy comprises player movement information and a goal of the strategy;
determining a success rate of the strategy based on historical data of the at least one player in the sports contest;
in response to determining that the success rate is less than a threshold success rate, identifying game obstacles in instances where the strategy was implemented by the at least one player and did not achieve the goal;
determining a modified strategy that (1) minimizes encounters of the at least one player with the game obstacles and (2) achieves the goal of the strategy, wherein an encounter represents a moment in the sports contest when the at least one player is within a threshold distance from any game obstacle; and
outputting a training procedure for implementing the modified strategy for presentation to the at least one player.

18. The non-transitory computer readable medium of claim 17, further comprising instructions for:
in response to determining that the success rate is not less than a threshold success rate, outputting a different training procedure for implementing the received strategy for presentation to the at least one player.

19. The non-transitory computer readable medium of claim 17, wherein an instruction for determining the modified strategy comprises instructions for:
identifying an original path of movement that intersected with a game obstacle;
identifying a different path of movement that can avoid intersecting with the game obstacle; and
determining the modified strategy such that the original path is replaced with the different path.

20. The non-transitory computer readable medium of claim 17, wherein the training procedure is a step-by-step instructive output that teaches the at least one player when and what actions to perform during the sports contest.
